(19) United States
(12) Patent Application Publication
(10) Pub. No.: US 2010/0198512 A1
(43) Pub. Date: Aug. 5, 2010

(54) METHOD AND APPARATUS FOR PROVIDING RELIABLE EXTENDED EPHEMERIS QUALITY INDICATORS

(76) Inventors: Wentao ZHANG, Cupertino, CA (US); Shaowel Han, Palo Alto, CA (US)

Correspondence Address: PILLSBURY WINTHROP SHAW PITTMAN LLP, P.O. BOX 10500, MCLEAN, VA, 22102, US

(21) Appl. No.: 12/363,556

(22) Filed: Jan. 30, 2009

(51) Int. Cl. G01C 21/00

(52) U.S. Cl. 701/226

(57) ABSTRACT

The present invention is related to location positioning systems, and more particularly, to a method and apparatus for providing reliable extended ephemeris information and indicators of quality. According to one aspect, the invention employs a concept of Approximate Accuracy Symmetry, in which a history of broadcast ephemerides is logged for each satellite, and used as a reference to evaluate the potential accuracy of the predicted orbit for each satellite in the future. According to further aspects, the desired accuracy information for the extended ephemerides can be reliably provided in advance.

### FIELD OF THE INVENTION

The present invention is related to location positioning systems, and more particularly, to a method and apparatus of providing reliable and accurate extended ephemeris information.

### BACKGROUND OF THE INVENTION

With the development of radio and space technologies, several satellites based navigation systems (i.e. satellite positioning system or “SPS”) have already been built and more will be in use in the near future. SPS receivers, such as, for example, receivers using the Global Positioning System (“GPS”), also known as NAVSTAR, have become commonplace. Other examples of SPS systems include but are not limited to the United States (“U.S.”) Navy Navigation Satellite System (“NNSS”) (also known as TRANSIT), LORAN, Shoran, Decca, TACAN, NAVSTAR, the Russian counterpart to NAVSTAR known as the Global Navigation Satellite System (“GLONASS”) and any future Western European SPS such as the proposed “Galileo” program. As an example, the U.S. NAVSTAR GPS system is described in GPS Theory and Practice, Fifth ed., revised edition by Hofmann-Wellenhof, Lichtenegger and Collins, Springer-Verlag Wien New York, 2001, which is fully incorporated herein by reference.

The U.S. GPS system was built and is operated by the United States Department of Defense. The system uses twenty-four or more satellites orbiting the earth at an altitude of about 11,000 miles with a period of about twelve hours. These satellites are placed in six different orbits such that at any time a minimum of six satellites are visible at any location on the surface of the earth except in the polar region. Each satellite transmits a time and position signal referenced to an atomic clock. A typical GPS receiver locks onto this signal and extracts the data contained in it. Using signals from a sufficient number of satellites, a GPS receiver can calculate its position, velocity, altitude, and time.

A GPS receiver typically has to acquire and lock onto at least four satellite signals in order to derive the position and time. Usually, a GPS receiver has many parallel channels with each channel receiving signals from one visible GPS satellite. The acquisition of the satellite signals involves a two-dimensional search of carrier frequency and the pseudo-random number (PRN) code phase. Each satellite transmits signals using a unique 1023-chip long PRN code, which repeats every millisecond. The receiver locally generates a replica carrier to wipe off residue carrier frequency and a replica PRN code sequence to correlate with the digitized received satellite signal sequence. During the acquisition stage, the code phase search step is a half-chip for most navigational satellite signal receivers. Thus the full search range of code phase includes 2046 candidate code phases spaced by a half-chip interval. The carrier frequency search range depends upon the Doppler frequency due to relative motion between the satellite and the receiver. Additional frequency variation may result from local oscillator instability.

The signals from the navigational satellites are modulated with navigational data at 50 bits/second (i.e. 1 bit/20 msec). This navigational data consists of ephemeris, almanac, time information, clock and other correction coefficients. This data stream is formatted as sub-frames, frames and super-frames. A sub-frame consists of 300 bits of data and is transmitted for 6 seconds. In this sub-frame a group of 30 bits forms a word with the last six bits being the parity check bits. As a result, a sub-frame consists of 10 words. A frame of data consists of five sub-frames transmitted over 30 seconds. A super-frame consists of 25 frames sequentially transmitted over 12.5 minutes.

The first word of a sub-frame is always the same and is known as TLM word and first eight bits of this TLM word are preamble bits used for frame synchronization. A Barker sequence is used as the preamble because of its excellent correlation properties. The other bits of this first word contains telemetry bits and is not used in the position computation. The second word of any frame is the HOW (Hand Over Word) word and consists of TOW (Time Of Week), sub-frame ID, synchronization flag and parity with the last two bits of parity always being ‘0’s. These two ‘0’ s help in identifying the correct polarity of the navigation data bits. The words 3 to 10 of the first sub-frame contains clock correction coefficients and satellite quality indicators. The 3 to 10 words of the sub-frames 2 and 3 contain ephemeris. These ephemeris are used to precisely determine the position of the GPS satellites. These ephemeris are uploaded every two hours and are valid for four hours to six hours. The 3 to 10 words of the sub-frame 4 contain ionosphere and UTC time corrections and almanac of satellites 25 to 32. These almanacs are similar to the ephemeris but give a less accurate position of the satellites and are valid for six days. The 3 to 10 words of the sub-frame 5 contain only the almanacs of different satellites in different frames. The super frame contains twenty five consecutive frames. While the contents of the sub-frames 1, 2 and 3 repeat in every frame of a superframe except the TOW and occasional change of ephemeris every two hours. Thus the ephemeris of a particular signal from a satellite contains only the ephemeris of that satellite repeating in every sub-frame. However, almanacs of different satellites are broadcast in-turn in different frames of the navigation data signal of a given satellite. Thus the 25 frames transmit the almanac of all the 24 satellites in the sub-frame 5.Any additional spare satellite almanac is included in the sub-frame 4.

The almanac and ephemeris are used in the computation of the position of the satellites at a given time. The almanacs are valid for a longer period of six days but provide a less accurate satellite position and Doppler compared to ephemeris. Therefore, almanacs are not used when a fast position fix is required. On the other hand, the accuracy of the computed receiver position depends upon the accuracy of the satellite positions which in-turn depends upon the age of the ephemeris. The use of current ephemeris results in better and faster position estimation than one based on non-current or obsolete ephemeris. Therefore, it is necessary to use current ephemeris to get a fast receiver position fix.

A GPS receiver may acquire the signals and estimate the position depending upon the already available information. In the ‘hot start’ mode the receiver has current ephemeris and the position and time are known. In another mode known as ‘warm start’ the receiver has non-current ephemeris but the initial position and time are known as accurately as the in the case of previous ‘hot start’. In the third mode, known as ‘cold start’, the receiver has no knowledge of position, time or ephemeris. As expected the ‘hot start’ mode results in low Time-To-First-Fix (TTFF) while the ‘warm start’ mode which has non-current ephemeris may use that ephemeris or the almanac resulting in longer TTFF due to the less accurate Doppler estimation and ephemeris downloading. The ‘cold start’ takes still more time for the first position fix as there is no data available to aid signal acquisition and position fix.

Therefore, it is necessary to keep the ephemeris in the receiver current for a fast TTFF. Current ephemeris also helps when the received signal is weak and the ephemeris can not be downloaded. Some issued patents teach receiving the ephemeris through an aiding network or remote server instead of from an orbiting satellite. However, this approach results in higher cost and requires additional infrastructure. Another approach to keeping ephemeris current, without using a remote server, is to automatically download it from satellites in the background, such as described in U.S. Pat. No. 7,435,357.

Some commercially available products such as SiRF InstantFixII from SiRF Technologies of San Jose, Calif. use extended ephemeris to improve start-up times without requiring network connectivity. With one observation of each satellite, SiRFInstantFixII accurately predicts satellite positions for up to three days—removing the need to download satellite ephemeris data at subsequent start-ups—resulting in full navigation in as little as five seconds, and with routine 7 meter accuracy. Moreover, such extended ephemeris products not only start tracking satellites and navigating more quickly, they can do it using signals much weaker than those needed to obtain satellite location data the traditional way, removing the barrier that often blocks successful navigation under tough GPS signal conditions.

Nevertheless, some challenges remain. For example, a common challenge facing up to date ephemeris extension technologies is the difficulty to reliably tell the accuracy of the extended ephemerides in advance. However, this kind of information (or indicator) is very important and always desired in real time for those applications that use the extended ephemerides.

Some alternatives or prior state-of-the-art for indicating the accuracy of orbital predictions is based on statistics of orbital predictions in the past few months, and assume that the accuracies of future orbital predictions for all SVs follow the statistical pattern. Unfortunately, the present inventors have recognized that orbital prediction accuracy varies substantially from time to time, from satellite to satellite. Therefore statistics may not provide a close approximation of the actual accuracy for a specified satellite at a specified time. It often happens that the statistics say accuracy is good but actual accuracy is poor, or the statistics says accuracy is bad but actual accuracy is good.

Accordingly, a need remains for an accurate and reliable way to ensure the accuracy of information used for performing extended ephemeris.

### SUMMARY OF THE INVENTION

The present invention is related to location positioning systems, and more particularly, to a method and apparatus for providing reliable extended ephemeris information and indicators of quality related thereto. According to one aspect, the invention employs a concept of Approximate Accuracy Symmetry, in which a history of broadcast ephemerides is logged for each satellite, and used as a reference to evaluate the potential accuracy of the predicted orbit for each satellite in the future. According to further aspects, the desired accuracy information for the extended ephemerides can be reliably provided in advance.

The advantages of this invention over the conventional alternatives include that each satellite is treated individually, and thus the invention allows insight into the differences among different satellites. Another advantage is that the invention derives backward orbit upon each forward orbit prediction, and thus takes into account the fact that the orbital prediction performance of each satellite varies with time. In short, the extended ephemeris accuracy indicators provided by the present invention are time-dependent and satellite-dependent, which are more realistic and reliable than the conventional alternatives.

In furtherance of the above and other aspects, a method for providing reliable extended ephemeris information according to embodiments of the invention includes logging a history of broadcast ephemerides for each of a plurality of satellites; and determining the accuracy of a respective predicted orbit for each of the satellites in the future using the logged history.

In additional furtherance of the above and other aspects, a method for performing GPS navigation according to embodiments of the invention includes determining potential accuracy of predicted orbits for each of a plurality of satellites; performing orbit prediction for certain of the plurality of satellites determined to be accurate; and using the predicted orbits to determine a navigation solution.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of an example implementation of principles of the invention;

FIG. 2 is a diagram illustrating an accuracy symmetry concept according to aspects of the present invention;

FIG. 3 is a chart providing experimental results illustrating the accuracy symmetry concept of the present invention;

FIG. 4 is a flowchart illustrating an example extended ephemeris accuracy validation methodology that can be performed in accordance with aspects of the invention;

FIG. 5 is a diagram illustrating an extended accuracy symmetry concept according to aspects of the present invention;

FIG. 6 is a flowchart illustrating another example extended ephemeris accuracy validation methodology that can be performed in accordance with aspects of the invention; and

FIGS. 7 and 8 are block diagrams illustrating example system architectures in which embodiments of the invention can be practiced.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

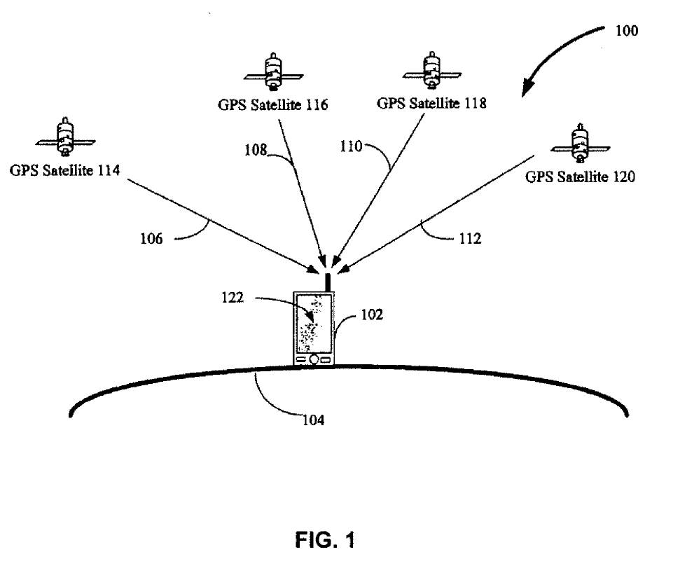

FIG. 1 illustrates an example implementation of embodiments of the invention. As shown in FIG. 1, GPS satellites (i.e. SVs) 114, 116, 118 and 120 broadcast signals 106, 108, 110 and 112, respectively, that are received by receiver 122 in handset 102, which is located at a user position somewhere relatively near the surface 104 of earth.

Handset 102 can be a personal navigation device (PND, e.g. from Garmin, TomTom, etc.) or it can be a cell or other type of telephone with built-in GPS functionality, or any GPS device embedded in tracking applications (e.g. automotive tracking from Trimble, package or fleet management tracking from FedEx, child locator tracking applications etc).

Receiver 122 can be implemented using software and/or hardware, including GPS chipsets such as SiRFstarIII GSD3tw or SiRFstar GSC3e from SiRF Technology and BCM4750 from Broadcom Corp., as adapted and/or supplemented with functionality in accordance with the present invention, and described in more detail herein. More particularly, those skilled in the art will be able to understand how to implement the present invention by adapting and/or supplementing such chipsets and/or software with the frame synchronization techniques of the present invention after being taught by the present specification.

Signals 106, 108, 110 and 112 are well-known GPS signals in which three binary codes shift the satellite's transmitted L1 and/or L2 frequency carrier phase. Of particular interest, the C/A Code (Coarse Acquisition) modulates the L1 carrier phase. The C/A code is a repeating 1.023 MHz Pseudo Random Noise (PRN) Code. This noise-like code modulates the L1 carrier signal, “spreading” the spectrum over a 1 MHz bandwidth. The C/A code repeats every 1023 bits (one millisecond). There is a different C/A code PRN for each SV. GPS satellites are often identified by their PRN number, the unique identifier for each pseudo-random-noise code. The C/A code that modulates the L1 carrier is the basis for the civil uses of GPS.

Receiver 122 produces the C/A code sequence for a specific SV with some form of a C/A code generator. Modem receivers usually store a complete set of pre-computed C/A code chips in memory, but a hardware shift register implementation can also be used. The C/A code generator produces a different 1023 chip sequence for each phase tap setting. In a shift register implementation the code chips are shifted in time by clewing the clock that controls the shift registers. In a memory lookup scheme the required code chips are retrieved from memory. The C/A code generator repeats the same 1023-chip PRN-code sequence every millisecond. PRN codes are defined for up to 1023 satellite identification numbers (37 are defined for satellite constellation use in the ICD but system modernization may use more). The receiver slides a replica of the code in time until there is correlation with the SV code.

As is known, signals from at least four SVs are usually needed before receiver 122 can provide a 3-dimensional navigation solution (only three satellites are required for a 2-dimensional navigation solution, e.g. by using known height). Accordingly, receiver 122 typically enters a predetermined sequence to acquire and extract the required data from each of signals 106, 108, 110 and 112. In a first step, acquisition, receiver 122 acquires signals 106, 108, 110 and 112 by correlating the unique C/A code corresponding to SVs 114, 116, 118 and 120 with received RF energy at the antenna of handset 102 and determining that these received signals have sufficient strength (e.g. carrier to noise ratio C/N₀) to use in subsequent processing. In a next step, track, the receiver 112 locks onto the C/A code for each acquired SV, which repeats every 1 msec. Next, receiver 112 synchronizes to the data bit in each signal 106, 108, 110 and 112, which occurs once over 20 msec. Then receiver 112 determines the frame boundary of the received bits in signals 106, 108, 110 and 112. At this point navigation can begin, for example by trilateration techniques known to those skilled in the art.

As is known, computing a navigation solution using trilateration requires information about the current clock and position of satellites being tracked, which is usually obtained from ephemeris data. As mentioned above, it takes time to download ephemeris (usually over 30 seconds), which greatly increases TTFF in conditions where up-to-date ephemeris is not already available (e.g. a “cold start”). Accordingly, ephemeris extension technologies attempt to reduce TTFF by using previously predicted satellite position and clock for the current period based on stored or received ephemeris information instead of waiting for current ephemeris downloading from satellites. Most ephemeris extension technologies perform orbital integration from a given initial point in time associated with the stored ephemeris information to a user specified time (usually the time when the receiver is first turned on and ready to navigate). The predicted satellite position is then used in the navigation solution until a new set of broadcast ephemeris information is received or the accuracy is not good enough.

However, for applications on standalone client devices, as also mentioned above, so far there is no efficient way to know in advance how accurate the predicted satellite position will be for any given satellite. Accordingly, it is possible that an unreliable navigation solution will be provided if any unreliable predicted satellite position is used.

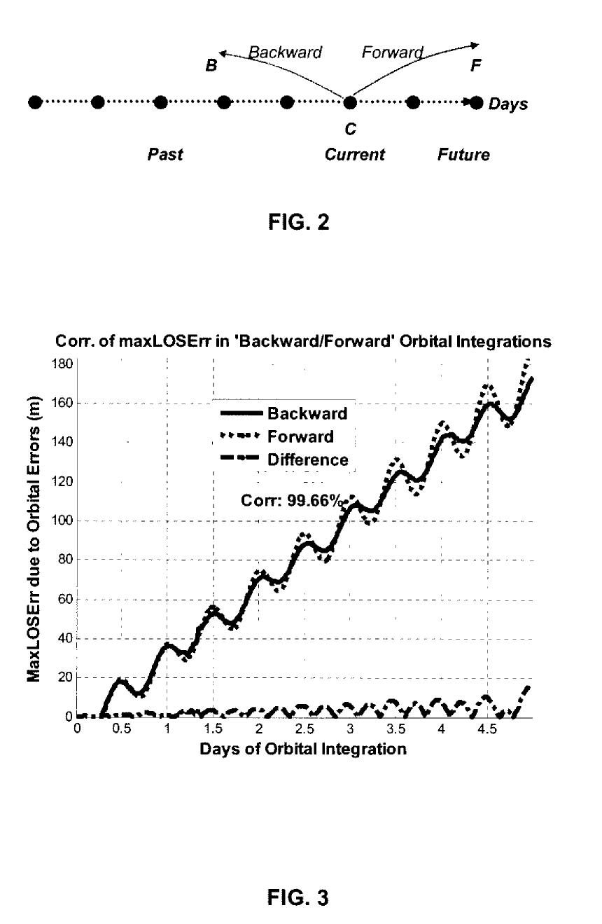

FIG. 2 illustrates the concept of ‘Approximate Accuracy Symmetry’ according to aspects of the invention. In FIG. 2, the dotted line stands for the time axis, with C representing ‘Current’, the left direction representing from ‘Current’ to the ‘Past’ and the right direction representing from ‘Current’ to the ‘Future’.

According to aspects of the invention, at time C, given an initial condition consisting of a satellite's position, velocity, solar radiation parameters, etc., it is possible to derive the satellite's orbit in either the ‘Future’ or the ‘Past’ through forward or backward orbital integration. Among other things, the present inventors recognize the concept ‘Approximate Accuracy Symmetry,’ which means that given the same initial condition, the accuracies of a given satellite's orbits derived forward (denoted as CF) and backward (denoted as CB) are approximately symmetrical to each other with respect to ‘Current’.

More particularly, in embodiments of the invention, the history broadcast ephemerides from ‘Current’ to the ‘Past’ are logged for each satellite, and can be used as references to evaluate the accuracy of the above CB orbit. Therefore, the accuracy of the orbit CF can be reliably derived from that of CB since it is symmetrical with respect to ‘Current’. In this way, the accuracy of the extended ephemerides for each satellite can be reliably provided in advance, and used to decide whether a particular satellite's stored ephemeris should be used for ephemeris extension calculations in a “warm start”, a “cold start” situation or the like.

The advantages of this invention over the above alternatives include the following aspects. Embodiments of the invention treat each satellite individually, and thus give insight into the differences among different satellites. Moreover, embodiments of the invention derive backward orbit upon each forward orbit prediction, and thus take into account the fact that the orbital prediction performance of each satellite varies with time. In short, the ephemeris extension accuracy indicators provided by embodiments of the invention are time-dependent and satellite-dependent, which are more realistic and reliable than the conventional alternatives.

FIG. 3 provides actual data that verifies the ‘Approximate Accuracy Symmetry’ Concept recognized by the present inventors. It should be noted that the orbits from true broadcast ephemerides are used as reference orbits. Therefore, the accuracy of the reference orbits is an additional factor affecting the accuracy symmetry of aforementioned ‘Backward’ and ‘Forward’ orbits. It should be further noted that, the following results are for illustration purposes, not representing the actual performance of any products.

Users of extended ephemeris are typically concerned particularly about how much range bias from the predicted orbital errors affect the LOS direction. Accordingly, the orbital prediction errors are projected to the LOS direction, in which the orbital errors translate to maximum range errors. FIG. 3 shows that it is possible to know the LOS errors due to predicted orbital errors by studying the backward orbital integration with variation of 0˜15 m over 5 days.

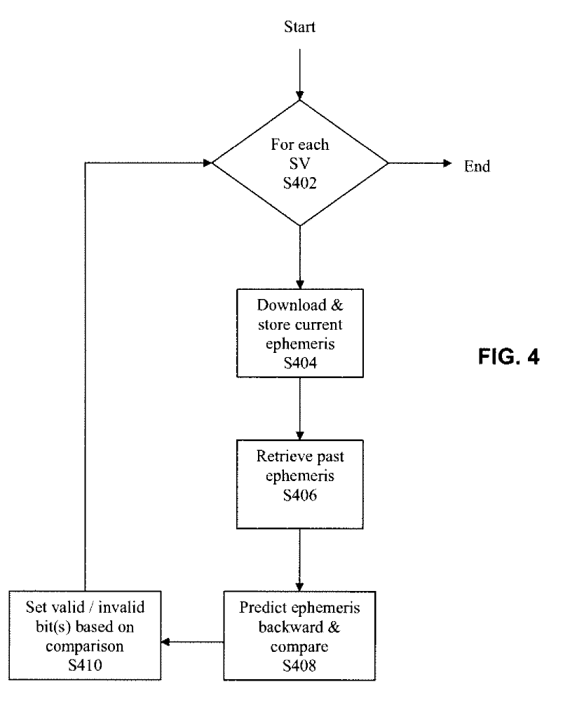

FIG. 4 is a flowchart illustrating an example method according to embodiments of the invention. In embodiments, the validation method is performed periodically when a receiver is turned on and SVs are being tracked. For example, a receiver can have a timer, and when a predetermined time has elapsed since the last time the method was performed, the method can be performed again. Additionally or alternatively, when a receiver has been turned on and begins tracking SVs, the receiver can check whether stored information associated with the validation method is aged by a threshold amount, and perform the method again if so. Still further, the receiver can simply perform the method once each time the receiver is turned on and/or new SVs are being tracked, or continuously in a background mode, for example, while the receiver is on. Many other alternatives are possible.

In the example of FIG. 4, for each SV being tracked (step S402), the current broadcast ephemeris information is downloaded and stored (step S404). The past ephemeris for the SV and its associated time is retrieved in step S406. Ephemeris prediction techniques are used, but in reverse, from the current time and initial condition to “predict” the SV's orbit at the past time associated with the stored ephemeris (step S408). Then, the predicted orbit and the stored orbit information are compared. In step S410, the method determines whether the difference between the “predicted” and stored ephemeris exceeds a threshold, and sets one or more valid/invalid/error level bit(s) for the SV based on the determination (step S410). The bit(s) provide a quality indicator for the SV at a future time that corresponds to, or symmetrical to, the past time. For example, if the backward “predicted” ephemeris is one day old, and by comparing it to the logged old BE's, if the backward “predicted” ephemeris is within a given accuracy threshold (i.e. a predefined reliability level), then the quality indicator provides an indication that extended ephemeris for that SV will be reliable for at least one day in the future. The method then returns to step S402 and ends if all the SV's have been processed.

It should be noted that any one of several known or proprietary ephemeris extension or prediction techniques may be used, for example the orbital integration techniques described in W. Zhang et al., “SiRF Instant Fix II Technology,” ION GNS 2008, Sept. 2008, incorporated herein by reference, and those skilled in the art will appreciate how to perform such “prediction” techniques backwards in time, rather than for the future. Accordingly, even further details thereof will be omitted here for the sake of clarity of the invention.

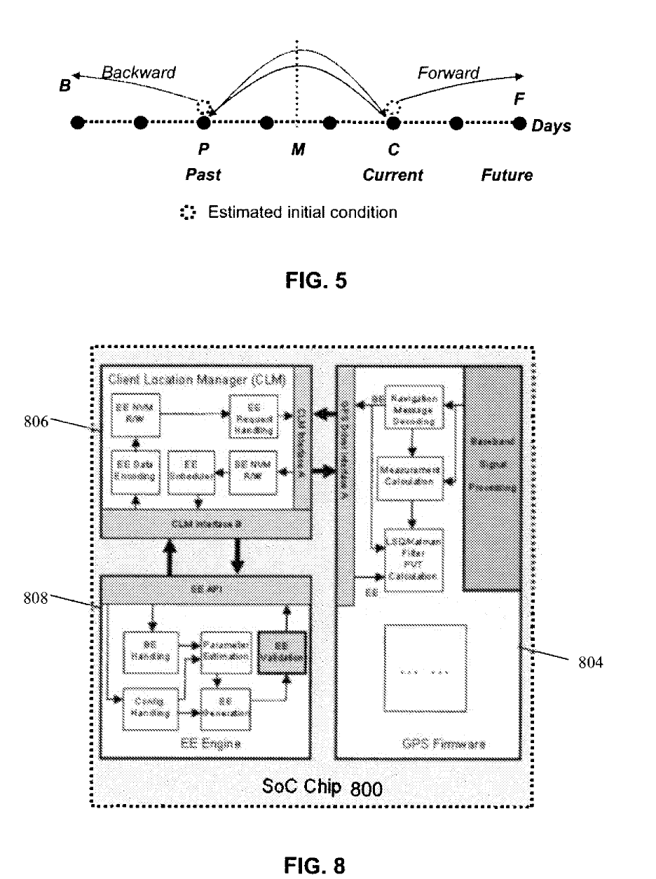

FIG. 5 illustrates an extension of the above ‘Approximate Accuracy Symmetry’ concept, where P is a moment in the ‘Past’, and M is the middle of the moments P and C. The period PC is referred to as observation period here.

According to certain aspects of this embodiment, the present inventors recognize that it may not always be possible to accurately know or derive the initial condition (i.e. a satellite's position, velocity, solar radiation parameters, etc.) at any given “current” time for a given satellite. Additionally or alternatively, the accuracy of the initial condition could be improved using BE's from many different times in the past. For example, in some applications, some parameters other than SV position and velocity such as solar radiation parameters are estimated offline in advance and hardcoded into a receiver's memory. However, for some SV's these hardcoded estimates may not be very good.

Accordingly, at ‘Current’ moment C, the given initial condition is estimated through the history data between P and C. By using the same estimation method and same history data between C and P, the orbital position, velocity and solar radiation parameters at moment P (i.e. ‘initial’ condition at P) can be also estimated. Since the same observation data is used, the estimated initial conditions at C and P should be at equivalent accuracy levels. So the extended concept of ‘Approximate Accuracy Symmetry’ as illustrated here specifies that the accuracy of the predicted CF orbit is approximately symmetrical to that of PB with respect to M.

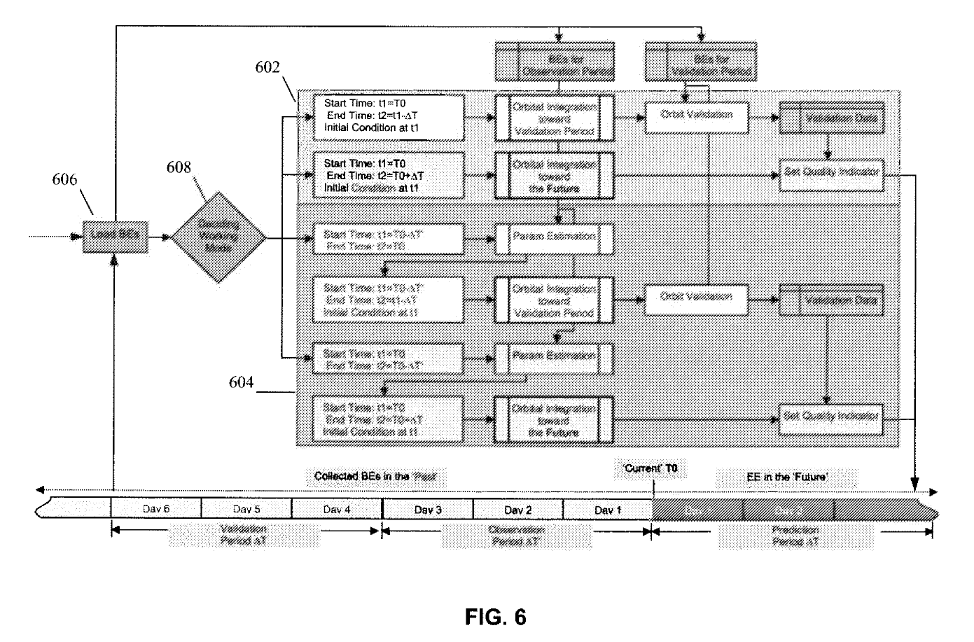

FIG. 6 is a flowchart illustrating an example methodology of embodiments of the present invention that incorporates the extended concept described above.

As shown in FIG. 6, there are two working modes 602 and 604 in the illustrated embodiment. In general, working mode 602 corresponds the first embodiment described above, where the initial condition is known or can be readily and accurately determined. Working mode 604 corresponds to the extended concept described above.

In embodiments, at any given current time T0 (e.g. at times such as those discussed in connection with the flowchart of FIG. 4), accuracy processing will be performed for each GPS satellite in the system. Block 606 represents that historical broadcast ephemerides (BE's) stored for the respective satellite being processed are loaded. In block 608, a decision is made which working mode 602 or 604 of accuracy processing should be performed.

The working mode decision can be based on many factors. For example, if the SV has recently performed initial condition estimation, working mode 602 may be chosen because additional initial condition estimation requires additional processing resources and/or may not result in substantially better accuracy, otherwise working mode 604 is chosen. As another alternative, if there is not enough processing power (e.g. available MIPS) or the receiver is very busy, working mode 602 may be chosen, otherwise working mode 604 is chosen. Still further, if there are not many BE's stored for the particularly satellite, working mode 602 may be chosen, otherwise working mode 604 is chosen. Those skilled in the art will appreciate that many combinations of these and other factors are possible.

In working mode 602, processing is performed similar to that depicted in FIG. 4. Accordingly, as shown in FIG. 6, using the initial condition at a (=T0), orbital integration is performed from t1 to a past time t2 (=T0−ΔT). Concurrently, orbital integration is also performed from t1 to a future time t2 (=T0+ΔT). The past time t2 corresponds to the times of the stored BE's for the particular SV and can range up to six days or more in certain embodiments. As in FIG. 4, the “predicted” past orbit is compared to the stored orbit information, and used to set a quality indicator for the future “predicted” orbit of the SV associated with the future time t2.

Working mode 604 differs from mode 602 primarily in that an additional process of parameter estimation must be performed to derive the initial condition before performing past and future orbital integration at times associated with stored BE's for a particular satellite. More particularly, as shown in FIG. 6, parameter estimation is performed to determine the initial condition at a past time t1=T0−ΔT′ using BE's collected for the SV over that past period comprising past time t1 to current time T0. As shown in FIG. 6, this is referred to as the “Observation Period”. In embodiments, the observation period can extend up to three to seven days in the past, but other alternatives are possible. Parameter estimation can be performed using various known or proprietary techniques, including the iterative integration techniques described in the incorporated publication.

As shown in FIG. 6, after the initial condition is estimated at past time t1, and similar to processing described above, orbital integration is performed toward the past (“backward”) and future (“forward”) and the “backward” orbit is compared to stored BE's to set the quality indicators for the SV at times corresponding to, or symmetrical to, the stored BE's, as in mode 602.

It should be noted that the accuracy information obtained through the accuracy symmetry concepts described above can be used to generate the desired quality indicators (e.g. flags or qualitative values) in various commercially available extended ephemeris products. Applicable products or systems include SGEE (Server generated Ephemeris Extension), CGEE (Client generated Ephemeris Extension), and Autonomy-I; Autonomy-IL InstantFix-I; InstantFix-II from SiRF Technologies. It should be further noted that the invention can be embodied in these and other conventional GPS products using software adaptations.

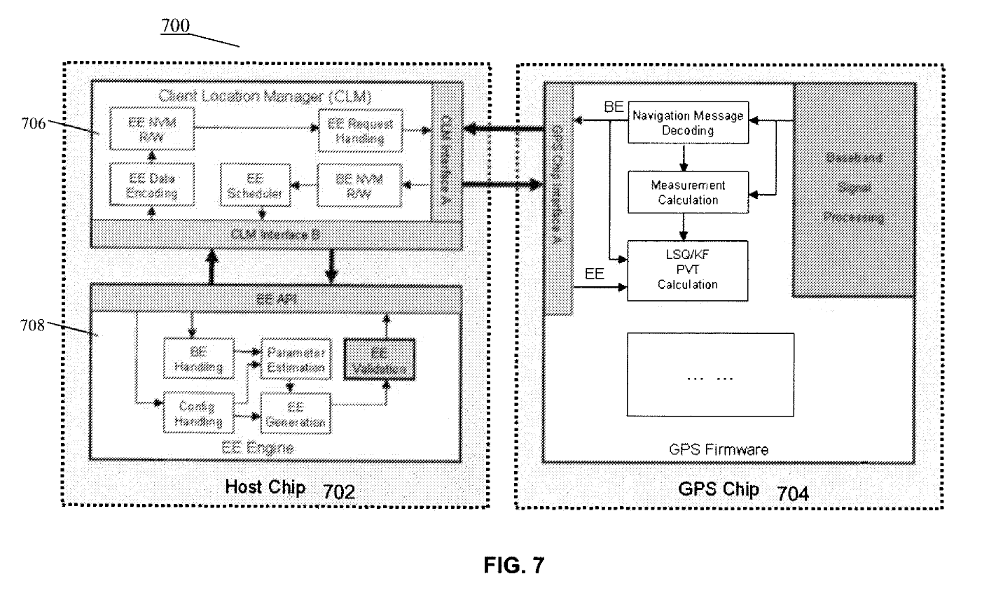

Example system architectures that can embody the methodology of the present invention are shown in FIG. 7 and FIG. 8 for discrete GPS and SoC GPS respectively.

More particularly, system 700 in FIG. 7 includes a host chip 702 and GPS chip 704. In example embodiments, host chip 702 can be implemented using a conventional CPU such as those provided by Intel, AMD, Freescale, ARM and others, perhaps as adapted with software having the ephemeris validation functionality of the present invention. In similar or other embodiments, GPS chip 704 can be implemented using a SiRFStar III, perhaps as adapted for use with the present invention. It should be apparent that chips 702 and 704 can be implemented with additional functionality not shown in FIG. 7, as well as different combinations and arrangements of functionality than shown in FIG. 7. However, details regarding such additional functionality or alternative arrangements will be omitted here for sake of clarity of the invention.

As further shown in FIG. 7, host chip 702 includes a client location manager (CLM) 706 and EE engine 708. CLM 706 generally includes functional components for managing the collection and storage of broadcast ephemeris downloaded by GPS chip 704, and for managing and scheduling the calculation of extended ephemeris calculated by EE engine 708. EE engine 708 generally includes functional components for calculating extended ephemeris based on received and/or stored broadcast ephemeris. Of particular note, EE engine 708 according to aspects of the invention includes EE validation functionality such as that described herein.

As shown in FIG. 7, GPS chip 704 can use broadcast ephemeris and/or extended ephemeris (including extended ephemeris as validated by aspects of the present invention) in performing navigation calculations.

Similarly, embodiments of the invention can be implemented on a system on a chip (SOC) 800 as shown in FIG. 8. Example platforms that can be adapted for use with the invention include SiRF Prima, Titan and Atlas SOCs. It should be apparent that chip 800 can be implemented with additional functionality not shown in FIG. 8, as well as different combinations and arrangements of functionality than shown in FIG. 8. However, details regarding such additional functionality or alternative arrangements will be omitted here for sake of clarity of the invention.

As further shown in FIG. 8, chip 800 includes a client location manager (CLM) 806 and EE engine 808. CLM 806 generally includes functional components for managing the collection and storage of broadcast ephemeris downloaded by GPS section 804, and for managing and scheduling the calculation of extended ephemeris calculated by EE engine 808. EE engine 808 generally includes functional components for calculating extended ephemeris based on received and/or stored broadcast ephemeris. Of particular note, EE engine 808 according to aspects of the invention includes EE validation functionality such as that described herein.

As shown in FIG. 8, GPS section 804 can use broadcast ephemeris and/or extended ephemeris (including extended ephemeris as validated by aspects of the present invention) in performing navigation calculations.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for providing reliable extended ephemeris information, comprising:
logging a history of broadcast ephemerides for each of a plurality of satellites; and
determining the accuracy of a respective predicted orbit for each of the satellites in the future using the logged history.

2. A method according to claim 1, further comprising:
selecting certain of the satellites based on the determined accuracy;
using extended ephemeris information for only the selected satellites.

3. A method according to claim 1, wherein the step of determining the potential accuracy includes:
predicting an orbit for each satellite at a past time; and
comparing the predicted orbit to an actual orbit at the past time using the logged history.

4. A method according to claim 1, further comprising determining an initial condition for the respective satellite using the logged history.

5. A method according to claim 3, further comprising determining an initial condition for the respective satellite using the logged history, wherein the predicting step includes performing orbital integration from the initial condition.

6. A method according to claim 4, wherein the initial condition comprises at least satellite position, velocity, and a solar radiation parameter.

7. A method according to claim 5, wherein the initial condition comprises at least satellite position, velocity, and a solar radiation parameter.

8. A method according to claim 3, further comprising setting a quality indicator for the respective satellite based on the comparing step, wherein the quality indicator describes the accuracy of a predicted orbit at a future time, wherein the future time is symmetrical to the past time with respect to a given point in time.

9. A method of performing GPS navigation, comprising:
determining potential accuracy of predicted orbits for each of a plurality of satellites;
performing orbit prediction for certain of the plurality of satellites determined to be accurate; and
using the predicted orbits to determine a navigation solution.

10. A method according to claim 9, wherein the step of determining the potential accuracy includes:
predicting an orbit for a respective one of the satellites at a past time; and
comparing the predicted orbit to an actual orbit at the past time.

11. A method according to claim 9, further comprising determining an initial condition for the respective satellite at a given time.

12. A method according to claim 10, further comprising determining an initial condition for the respective satellite at a given time, wherein the step predicting of predicting the orbit includes performing orbital integration from the initial condition.

13. A method according to claim 11, wherein the initial condition comprises at least satellite position, velocity, and a solar radiation parameter.

14. A method according to claim 12, wherein the initial condition comprises at least satellite position, velocity, and a solar radiation parameter.

15. A method according to claim 10, further comprising setting a quality indicator for the respective satellite based on the comparing step, wherein the quality indicator describes the accuracy of a predicted orbit at a future time, wherein the future time is symmetrical to the past time with respect to a given point in time.

16. An apparatus comprising circuitry that performs the method of claim 1.

17. An apparatus comprising circuitry that performs the method of claim 9.
